(19) United States
(12) Patent Application Publication
(10) Pub. No.: US 2016/0338531 A1
(43) Pub. Date: Nov. 24, 2016

(54) Cooking Apparatus and Method

(71) Applicants: Michael James McIntyre, Navan, County Meath (IE); Kieran Carolan, Castleknock, Dublin (IE)

(72) Inventors: Michael James McIntyre, Navan, County Meath (IE); Kieran Carolan, Castleknock, Dublin (IE)

(21) Appl. No.: 15/114,399

(22) PCT Filed: Jan. 26, 2015
(86) PCT No.: PCT/EP2015/051462

§ 371 Date: Jul. 27, 2016

(30) Foreign Application Priority Data
Jan. 27, 2014 (IE) S2014/0022

(51) Int. Cl. A47J 36/32; G08C 17/02

(52) U.S. Cl. CPC A47J 36/32; G08C 17/02

(57) ABSTRACT

The present invention relates to a cooking apparatus and method for cooking a food item using a cooking apparatus, the method characterised by the steps of: using transmission means of a remote computing device to send cooking control data to receiving means of the cooking apparatus when the transmission means is positioned near or adjacent to the receiving means, and operating a processor means of the cooking apparatus to process the cooking control data when received to perform a cooking process to cook a food item placed in a cooking cavity of the cooking apparatus. The present invention provides an oven that receives cooking control data or information from a remote mobile computing device, such as a smart phone or other portable hand-held, device. The cooking control data is processed by the cooking apparatus for the purposes of setting cooking instructions specific to the food item to be cooked.

The present invention relates to a cooking apparatus and cooking method for a food item.

Various types of ovens for cooking food items are known. With certain categories of ovens users manually interact with oven controls in order provide the necessary input to the oven so that it will cook a food item as is required. Such ovens can also include pre-programmed or stored cooking processes for various food items so that to cook a food item a user manually selects an appropriate cooking process based on the type of food item to be cooked. In such ovens it is therefore necessary for each and every food item to have a pre-programmed cook profile, which is clearly onerous, and is moreover problematic since users may select an incorrect program which may cause a food item to be incorrectly cooked or not cooked at all. Additionally, ovens have limited memory capacity to store such cook profiles.

Other categories of ovens are adapted to receive the required input through the use of barcodes attached to a food item, the bar code or tag encoding or storing cooking data for the food item, which when scanned by an oven reader is transmitted to a controller in the oven which controls heating times and output levels of the oven so that the food item is cooked. However, the use of such ovens suffer from the drawback that a barcode or tag must be attached to the product, which is an extra manufacturing step and therefore an extra expense. Moreover, such barcodes are susceptible to damage and disfiguration during manufacturing and use, and/or misuse, such as by inappropriate re-use, by users.

Additionally, scanning a barcode associated with a product using a barcode scanner is fraught with danger as the product barcode may be interpreted as that of a completely different product, or in some cases, may not be interpreted as a barcode for a product at all thereby rendering an error code when scanned.

A further problem that exists is that certain products are purchased chilled (0 to 4 degrees Celsius) for consumption on the day, however, some of these products are not cooked and consumed on the day of purchase and are frozen for future use by the consumer. This presents a problem as there are no specific cooking instructions promulgated by the manufacturer on how to cook this product from its frozen state.

It would be desirable for a cooking apparatus and method which goes someway towards overcoming the above problems, and/or provides the public and/or industry with a useful alternative.

Further aspects of the present invention will become apparent form the ensuing description which is given by way of example only.

Accordingly, in a first aspect there is provided a cooking apparatus for cooking a food item comprising:
receiving means for receiving cooking control data sent from transmission means of a remote computing device;
characterised in that the transmission means is operable to send the cooking control data when positioned near or adjacent to the receiving means of the cooking apparatus, and the cooking control data when received is processed by a processor means of the cooking apparatus to thereby control the cooking apparatus to perform a cooking process to cook the food item in a cooking cavity of the cooking apparatus.

In another embodiment of the invention, the cooking apparatus comprises temperature sensing means operable to measure or sense or detect a temperature of a food item placed in the cooking cavity of the cooking apparatus.

In another embodiment of the invention, the temperature sensing means is operable to measure or sense or detect a surface temperature of the food item placed in the cooking apparatus.

In another embodiment of the invention, the temperature sensing means is a thermometer, such as a laser thermometer.

In another embodiment of the invention, the temperature measured or sensed or detected is transmitted to the processor means and the processor means is operable to determine whether the food item is in a frozen state or a non-frozen state according to the temperature.

In another embodiment of the invention, if the food item is determined as being in a frozen state then the cooking apparatus is operable to perform a defrost process to fully or substantially defrost the food item prior to performing the cooking process according to the cooking control data, but if the food item is determined as being in a non-frozen state then the cooking apparatus performs the cooking process according to the cooking control data to cook the food item.

In another embodiment of the invention, the cooking apparatus and/or the remote computing device is further operable to generate a prompt for the user to select whether the food item to be cooked is in a frozen state or a non-frozen state, whereby if the user provides an input to indicate that the food item to be cooked is in a frozen state then the cooking apparatus is operable to perform a defrost process prior to performing the cooking process, and if the user provides an input to indicate that the food item to be cooked is in a non-frozen state then the cooking apparatus performs the cooking process to cook the food item.

In another embodiment of the invention, the transmission means is provided by near field communication (NFC) means integrated with the remote computing device, such that the cooking control data is sent from the NFC enabled remote computing device to an NFC enabled receiving means of the cooking apparatus.

In another embodiment of the invention, the remote computing device is a mobile computing device, such as a smart phone or other mobile device, having an NFC chip.

In another embodiment of the invention, the transmission means is provided by Bluetooth communications means such that the cooking control data is sent from the Bluetooth enabled remote computing device to a Bluetooth enabled receiving means of the cooking apparatus.

In another embodiment of the invention, the Bluetooth enable remote computing device is a mobile computing device, such as a smart phone or other mobile device, having Bluetooth functionality.

In another embodiment of the invention, the cooking control data is downloaded from a remote database via a software application executing on the remote computing device.

In another embodiment of the invention, a user selects from user interface means displayed on display means of the remote computing device the food item for which cooking control data is to be transmitted to the cooking apparatus, the user interface means generated on the remote computing device by a software application executing on the remote computing device.

In a further aspect the present invention relates to a method for cooking a food item using a cooking apparatus, the method being characterised by the steps of:
using transmission means of a remote computing device to send cooking control data to receiving means of the cooking apparatus when the transmission means is positioned near or adjacent to the receiving means, and
operating a processor means of the cooking apparatus to process the cooking control data when received to perform a cooking process to cook a food item placed in a cooking cavity of the cooking apparatus.

In another embodiment of the invention, the method comprises the further step of: operating a temperature sensing means of the cooking apparatus to measure or sense or detect a temperature of a food item placed in the cooking cavity of the cooking apparatus.

In another embodiment of the invention, the method comprises the further step of: transmitting the temperature measured or sensed or detected by the temperature sensing means to processor means of the cooking apparatus, whereby the processor means performs a step of determining whether the food item in the cooking cavity is in a frozen state or a non-frozen state according to the temperature.

If the food item is determined by the processor means as being in a frozen state then the method comprises the further step of: operating the cooking apparatus to perform a defrost process to fully or substantially defrost the food item prior to performing the cooking process according to the cooking control data, and whereby if the food item is determined as being in a non-frozen state then operating the cooking apparatus to perform the cooking process to cook the food item according to the cooking control data.

In another embodiment of the invention, the method comprises the further step of: displaying user interface means on display means of the remote computing device, the user interface means operable to enable a user to input a selection confirming whether the food item to be cooked is in a frozen state or a non-frozen state, and whereby if the user provides an input to indicate that the food item is in a frozen state then the cooking apparatus is operable to perform a defrost process to fully or substantially defrost the food item prior to performing the cooking process according to the cooking data, but if the user provides an input to indicate that the food item to be cooked is in a non-frozen state, then the cooking apparatus immediately performs the cooking process to cook the food item according to the cooking control data.

In another embodiment of the invention, the method comprises the further step of: integrating near field communication (NFC) means with the remote computing device and the cooking apparatus such that the cooking control data is sent from the NFC enabled device to the NFC receiving means of the cooking apparatus.

In another embodiment of the invention, the method comprises the further step of: integrating Bluetooth communications means with the remote computing device and the cooking apparatus such that the cooking control data is sent from the Bluetooth enabled remote computing device to Bluetooth enabled receiving means of the cooking apparatus.

In another embodiment of the invention, the method comprises the further step of: downloading the cooking control data to the remote computing device from a remote database via a software application executing on the remote computing device.

In another embodiment of the invention, the method comprises the further step of: providing cooking control data for a range of food items to or via the software application, whereby cooking control data for a selected food item is transmitted to the cooking apparatus from the remote computer device.

In a further aspect the present invention relates to an apparatus for cooking a food item substantially as herein described with reference to and as shown in the accompanying drawings and examples.

In a further aspect the present invention relates to a method for cooking a food item substantially as herein described with reference to and as shown in the accompanying drawings and examples.

The present invention provides an oven that receives cooking control data or information from a remote mobile computing device, such as a smart phone or other portable hand-held, device. Use of NFC or Bluetooth enables the exchange of data in the form of cooking control data from an application running on the mobile computing device to a processor or central communications controller of the oven. The cooking control data is processed by the cooking apparatus for the purposes of setting cooking instructions specific to the food item to be cooked. A user need only hold the mobile computing device, which includes an NFC transmitter or Bluetooth functionality, proximate to the cooking apparatus, which includes an NFC receiver or reader, so that the cooking control data may be sent via the NFC or Bluetooth or other wireless control means to the cooking apparatus.

The provision of temperature sensing means operable to measure or sense or detect a temperature of a food item placed in the cooking apparatus enables the cooking apparatus to determine whether or not the food item placed in the cooking apparatus is frozen or not, and if its is to then automatically perform a defrost process in order to defrost the food item before the cooking process is initiated to fully cook the food item. The temperature sensing means may be activated manually or automatically, such as when the door of the cooking apparatus is opened or closed and/or when the cooking apparatus senses that a food item has been placed in the cooking apparatus.

In this way the present invention may determine if the product is chilled or frozen, the chilled cooking profile may be stored and transmitted to the oven and adjusted by a specially developed set of algorithms and data structures to ensure perfect cooking even if the product is placed in the oven when frozen.

The cooking apparatus also comprises a cooking control means, in the form of a processor means, operable to carry out the cooking process based on the cooking control data, to apply correction factors, and to send back to the originating mobile device which sent the cooking control data a record of all actions carried out by the control apparatus, including the type and number of items cooked. When cooking control data is received by the NFC chip or Bluetooth or other receiver a customised cooking process for that food item is thus activated within the oven.

It will be understood that a suitable cooking apparatus for use with the present invention would be an oven with a cooking cavity into which is placed a food item to be cooked by radiant convection, microwave, combination microwave and convection cooking, combination microwave and convection and quartz heating, as well as a steamer oven (any oven). The cooking elements may comprise one or more fan-assisted convection elements, one or more quartz elements and one or more microwave magnetrons. These are controlled by a main circuit board which connects to a smaller display board carrying a bespoke VFD (vacuum fluorescent display) and an interface to one front-panel membrane switch sub-assemblies.

The invention will be more clearly understood from the following description of some embodiments thereof, given by way of example only, with reference to the accompanying drawings, in which:

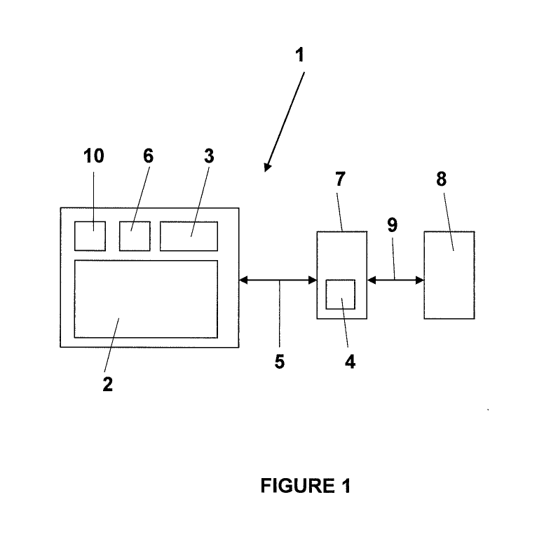

FIG. 1 is a block schematic of components in a cooking apparatus for use in performing the cooking method according to FIG. 1;

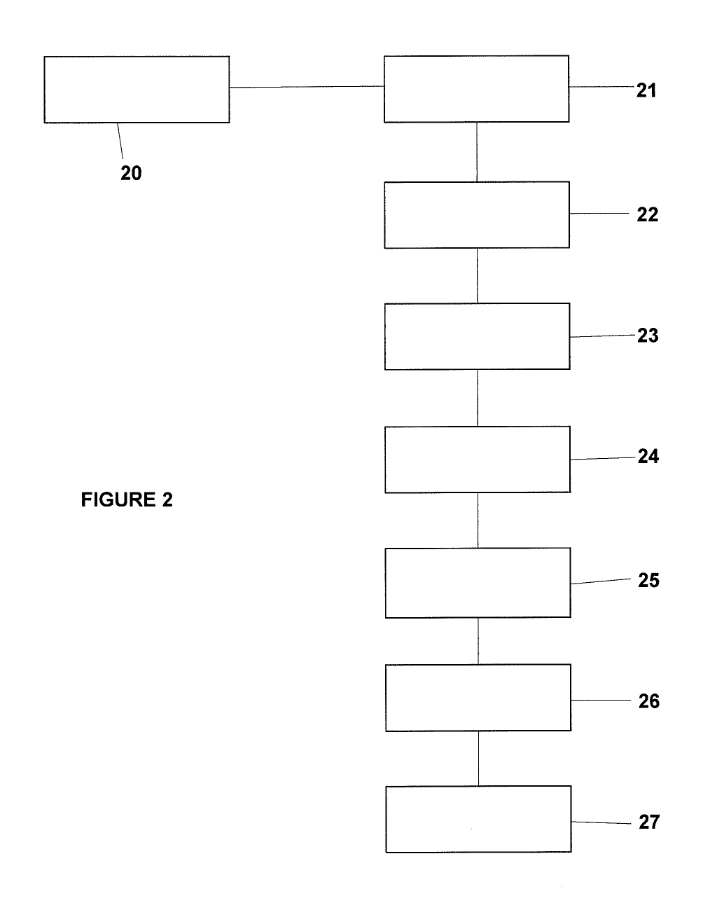

FIG. 2 is a flow diagram showing the steps in a cooking method according to the present invention, and

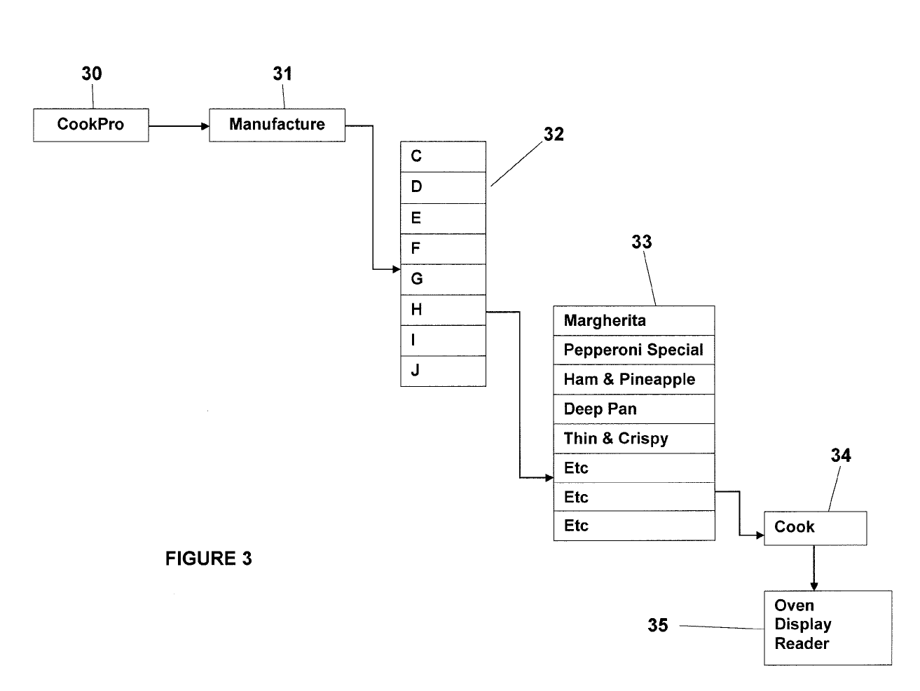

FIG. 3 is a stylised flow diagram showing steps in an exemplary embodiment according to the present invention.

Referring to the drawings, there is shown a cooking apparatus 1 for cooking a food item. The cooking apparatus 1 comprises a closable cooking cavity 2 into which is placed a food item to be cooked. Also shown is receiving means 3 for cooking control data sent from a transmission means 4. The transmission means 4 is provided by a device 7 having wireless communications means, such as, but not limited to, near field communication (NFC) means such that the cooking control data is sent from the NFC enabled device 7 to the receiving means 3 of the cooking apparatus 1 via a data transmission network 5. The NFC enabled device 7 may be a mobile computing device, such as a smart phone or other mobile device, having an NFC chip or other NFC enabling means. Similarly, the receiving means 3 of the oven 1 may be provided by an NFC chip and reader operable to interrogate and/or receive the cooking control data from the transmission means 4.

The present invention is thus concerned with a wireless communicative coupling, such as NFC or by way of an alternative, Bluetooth communication, being established for data transfer between a remote computing device, such as a smart phone or other type of processing device enabled for such wireless communications, and a cooking apparatus, such as an oven configured with computing processor means and adapted for such wireless communications.

The transmission means 4, whether NFC, Bluetooth or other suitable wireless transmissions means, is activated to send the cooking control data via the network 5 when it is located adjacent, near, beside or within a certain pre-defined proximity of the receiving means 3 of the cooking apparatus 1. In one embodiment, the transmission means 4 is activated to send the cooking control data via the wireless network 5 when it is located within or between a range of about 0 mm to 50 mm of the receiving means 3 of the cooking apparatus 1. Other ranges for the wireless transmission of cooking data according to the invention include: 0 mm to 100 mm, 0 to 200 mm, 0 mm to 300 mm, 0 mm to 400 mm, 0 mm to 500 mm or 0 mm to 1000 mm, although it will be understood that the operable proximity of the transmission means 4 and receiving means 3 may be adapted as necessary.

Thus by positioning the NFC or other wireless communications enabled mobile computing device 7 in proximity or adjacent or against to the cooking apparatus 1 housing the receiving means 3, the cooking data for a food item to be cooked may be sent to the NFC enabled receiving means 3 of the cooking apparatus 1. The cooking control data received by the receiving means 3 may then be processed by a processor means 6 of the cooking apparatus 1 to control the cooking apparatus 1 to perform a cooking process to cook the food item.

The cooking control data for a food item is downloaded to the NFC enabled mobile computing device 7 from a computing server 8 via a network 9, optionally via a software application or “app” executing on the mobile computing device 7. The user of a smart phone may log onto a website and download the application software containing cooking parameters for a range of food products. The software application may provide cooking control data for a range of food items able to be cooked by the cooking apparatus 1, and a user selects the food item to be cooked from a menu displayed as a user interface on display means of the mobile computing device 7, and this selection triggers the cooking control data contained in the application software to be transmitted to the cooking apparatus 1 when the NFC receiver of the cooking apparatus is activated and the NFC transmission means 4 is located adjacent, near, beside or within a certain pre-defined proximity of the NFC receiving means 3 of the cooking apparatus 1.

Although the above makes reference to transmission means 4 being NFC transmission means it will be understood that such transmission means 4 may also be provided by Bluetooth transmission means of a Bluetooth enabled mobile computing device 7 and Bluetooth enabled receiving means 3 of the cooking apparatus 1. Other modes for wireless communication between the mobile or remote computing device and the cooking apparatus are envisaged for establishing a communicative coupling and reference to NFC and Bluetooth only should in no way be seen as limiting.

The cooking apparatus further comprises temperature sensing means 10 operable to measure or sense or detect a temperature of a food item placed in the cooking apparatus 1. The temperature sensing means 10 is operable to measure or sense or detect a surface temperature of the food item placed in the cooking apparatus 1, and may optionally be a thermometer, such as a laser thermometer or other suitable temperature sensing device.

The temperature measured or sensed or detected is transmitted to the processor means, which is operable to determine whether the food item is in a frozen state or a non-frozen state according to the temperature. If the food item is determined as being in a frozen state then the cooking apparatus is operable to perform a defrost process prior to performing the cooking process, and if the food item is determined as being in a non-frozen state then the cooking apparatus performs the cooking process to cook the food item.

Turning now to FIG. 2, a cooking process according to the invention comprises the initial step 20 of a user switching on the cooking apparatus. At step 21 a user selects the previously downloaded application software executing on their mobile computing device or smart phone, and at step 22, selects from a user interface menu a product to be cooked.

At step 23, the user places their mobile computing device in proximity with the cooking apparatus, and then activates the NFC functionality, such as by pressing an NFC button on interface panel of the apparatus. This activates the NFC reader of the cooking apparatus, which in turn, at step 24, is operable to create a coupling for data transmission with the transmission means of the mobile computing device via which cooking control data is sent to the NFC enabled reader or receiving means of the oven. At step 25, the cooking apparatus now optionally begins the process of preparing to cook the food item by displaying on display means of the oven various confirmation requests from the user, such as “Have you removed all packaging and placed the food item in the oven?”, “Close Door”, and “Press start button” to start cooking. The time remaining in a cook process is also displayed and when cooking complete the oven will beep.

At step 26, temperature sensing means of the cooking apparatus is operable to measure or sense or detect a temperature of a food item placed in the cooking apparatus and transmit the temperature measured or sensed or detected to the processor means so that the processor means may determine whether the food item is in a frozen state or a non-frozen state according to the temperature. If the food item is determined as being in a frozen state then the method comprises the further step of the cooking apparatus first performing a defrost process prior to performing the cooking process in order to defrost the food item before it is cooked. However, if the food item is determined as being in a non-frozen state then the cooking apparatus performs the cooking process to cook the food item. The temperature sensing means may be activated manually or automatically, such as when the door of the cooking apparatus is opened or closed and/or when the cooking apparatus senses that a food item has been placed in the cooking apparatus.

At step 27, the cooking event is recorded, such as in a memory of the cooking apparatus. Optionally, the recorded information may be over written after a certain number of cooking events are recorded. A user may also optionally make a selection to allow the event information to be transmitted to mobile computing device and then to the back end server. Optionally the cooking apparatus may be provided with a connection to the Internet.

An exemplary embodiment of the present invention will now be described with reference to FIG. 3. Initially, a user selects the software application executing on a mobile computing device, such as a smart phone, for the invention. In FIG. 3 this application is indicated as the “CookPro App” 30. The user then has a number of options for locating the product to be cooked by the oven.

A first option includes a user scanning a barcode associated with or affixed to the product so that cooking control data for the product according to the bar code is obtained and downloaded from a back end server database via the “CookPro App” to the mobile computing device for transmission to the cooking apparatus.

A second option includes a user inputting details of the product, such as the product name, a reference code, or some other suitable identifier into a search function executing on the “CookPro App”. A back end server database comprising cooking control data for a range of products then performs a search for cooking control data for the product according to the identifier input by a user wherein if such cooking control data is located in the database they are then downloaded from the back end server database via the “CookPro App” to the mobile computing device for transmission to the cooking apparatus.

A third option for obtaining cooking control data is illustrated in FIG. 3 and includes a user selecting a manufacturer 31 from a list 32 of food manufacturers 31 (shown as manufacturers C, D, E etc.) provided on a scroll down menu displayed on the mobile computing device. In FIG. 3, the manufacturer is selected and the user may then select from a list of products 33 for the manufacturer. In the instance shown in FIG. 3, the manufacturer lists as its products a range of pizzas such that a user is then prompted to select a type of pizza from a further list, shown in FIG. 3, as including a margarita pizza, a pepperoni special pizza etc. When a product is selected, cooking control data for the selected product is then downloaded or transmitted to the remote computing device.

On download of the cooking control data to the mobile computing device via the “CookPro App” software application, or on selection of the product according to the method shown in FIG. 3, the user then selects the “Cook” option 34 provided by the application whilst placing the mobile computing device in proximity to the oven reader/NFC receiver/Bluetooth receiver to create a coupling for data transmission with the transmission means of the mobile computing device via which cooking control data is sent to the NFC or Bluetooth enabled oven reader or receiving means of the cooking apparatus. The user then follows the instructions displayed on the cooking apparatus 35, such as to “Open the oven door”, “Remove all product packaging”, “Place product in centre of the oven” and “Press Start”.

The present invention will also allow multi cooking of similar products from a specific manufacturer, such as two different types of fish, or fish and chips products from a manufacturer. It will also allow multi cooking of products from different manufacturers, such as, fish from one manufacturer and chips products from different manufacturer. It will be understood that such cooking instructions are specific to a product from a specific manufacturer, and are not therefore generic.

The present invention provides many advantages including that a food manufacturer is assured that their product will be cooked correctly every time using NFC or Bluetooth or other wireless technology as the means by which cooking control data is received by the oven. It will however be understood that the oven may also include other known methods for inputting cooking data for cooking a food item. The use of the application software on a mobile computing device, such as a smart phone, will lock the customer in to a manufacturer's product. If the customer elects to allow a cooking apparatus to send data back to the smart phone or mobile device they are able to send rewards to customers by way of vouchers, and have usage data by location, time of cooking and can validate marketing campaigns so that, for example, food items may be cooked during intervals in television programs and schedules. The owner of a smart phone with a NFC chip or Bluetooth functionality can log on to a website and download an app containing cooking parameters for a range of food products.

Other features include: a data base compiled based on each manufacturers products, data base management will be essential to accommodate manufacturers changes to specific products or product ranges, data exchange will be adapted so that when a product is selected by a user to be cooked then data relating to the selection, such as date and time stamped will be recorded. Also there is the opportunity to receive information back from the end user detailing their specific product usage that we can compile in our data base to enable coupon management, rewards, connectivity to social media, such as Facebook, Twitter.

Aspects of the present invention have been described by way of example only and it should be appreciate that additions and/or modifications may be made thereto without departing from the scope thereof as defined in the appended claims.

1.-24. (canceled)

25. A system for cooking a food item, comprising:
a computing device that transmits cooking control data that corresponds to a selected cooking protocol for said food item; and
a cooking apparatus, remote from said computing device, that has a cooking cavity, a processor, and a receiver, wherein said receiver receives said cooking control data from said computing device, said processor controls cooking within said cooking cavity, and said processor is controlled by said cooking control data.

26. The system according to claim 25, further including a temperature sensor within said cooking apparatus for detecting a temperature associated with said food item in said cooking cavity of said cooking apparatus.

27. The system according to claim 26, wherein said temperature sensor detects a surface temperature of said food item placed in said cooking cavity of said cooking apparatus.

28. The system according to claim 26, wherein said temperature sensor is a laser thermometer.

29. The system according to claim 26, wherein said processor analyzes said temperature associated with said food item to determine whether said food item is in a frozen state or a non-frozen state.

30. The system according to claim 29, wherein said processor adds a defrost protocol to said selected cooking protocol if said food item is determined as being in said frozen state, wherein said defrost protocol is operable to cause said cooking apparatus to at least substantially defrost said food item prior to performing said selected cooking protocol according to said cooking control data.

31. The system according to claim 29, further including an input for indicating that said food item is in said frozen state, wherein said processor adds a defrost protocol to said selected cooking protocol if said food item is indicated to be in said frozen state, wherein said defrost protocol is operable to cause said cooking apparatus to at least substantially defrost said food item prior to performing said selected cooking protocol according to said cooking control data.

32. The system according to claim 25, wherein said computing device communicates with said processor in said cooking apparatus via a near field communication means that is integrated within said computing device.

33. The system according to claim 24, wherein said computing device is a smart phone.

34. The system according to claim 24, further including a remote database, wherein said computing device communicates with said remote database and downloads said cooking control data from said remote database via a software application executing on said computing device.

35. The system according to claim 24, wherein a user selects from a user interface means displayed on a display means of said computing device said food item for which said cooking control data is to be transmitted to said cooking apparatus, said user interface means generated on said computing device by a software application executing on said computing device.

36. A method for cooking a food item using a cooking apparatus, said method comprising the steps of:
providing a computing device that transmits cooking control data, wherein said cooking control data corresponds to a selected cooking protocol for said food item; and
providing a cooking apparatus, remote from said computing device, that has a cooking cavity, a processor and a receiver, wherein said receiver receives said cooking control data from said computing device and said processor utilizes said cooking control data to execute said selected cooking protocol within said cooking chamber.

37. The method according to claim 16, further including the step of operating a temperature sensor to detect a temperature of said food item placed within said cooking cavity of said cooking apparatus.

38. The method according to claim 37, further including the step of utilizing said temperature sensor to determine if said food item placed within said cooking cavity is in a frozen state or a non-frozen state.

39. The method according to claim 38, further including adding a defrost protocol to said selected cooking protocol if said food item is determined as being in said frozen state, wherein said defrost protocol is operable to cause said cooking apparatus to at least substantially defrost said food item prior to performing said selected cooking protocol according to said cooking control data.

40. The method according to claim 38, further including providing an input for indicating that said food item to be cooked is in said frozen state, wherein said processor adds a defrost protocol to said selected cooking protocol if said food item is indicated to be in said frozen state, wherein said defrost protocol is operable to cause said cooking apparatus to at least substantially defrost said food item prior to performing said selected cooking protocol according to said cooking control data.

41. The method according to claim 36, further including integrating near field communications to transmit said cooking control data between said computing device and said cooking apparatus.

42. The method according to claim 36, further including integrating Bluetooth communication means to transmit said cooking control data between said computing device and said cooking apparatus.

43. The method according to claim 36, further including downloading said cooking control data to said computing device from a remote database via a software application executing on said computing device.

44. The method according to claim 43, further including providing cooking control data for a range of food items to or via said software application, wherein said cooking control data for a selected one of said food items is transmitted to said cooking apparatus from said computing device.
